(19) United States
(12) Patent Application Publication
(10) Pub. No.: US 2024/0328731 A1
(43) Pub. Date: Oct. 3, 2024

(54) FLUID MACHINE AND COOLING DEVICE

(71) Applicant: Nidec Corporation, Kyoto (JP)

(72) Inventors: Keisuke KAWATA, Kyoto (JP); Takehito TAMAOKA, Kyoto (JP); Toshihiko TOKESHI, Kyoto (JP)

(21) Appl. No.: 18/616,242

(22) Filed: Mar. 26, 2024

(30) Foreign Application Priority Data
Mar. 31, 2023 (JP) 2023-058491

(51) Int. Cl. F28F 27/00; F16K 15/02

(52) U.S. Cl. CPC F28F 27/00; F16K 15/026; F28F 2265/12

(57) ABSTRACT

A fluid machine includes a flow path including an outflow port of a fluid, a first portion through which the fluid flows from the other side to one side in a first direction, and a second portion through which the fluid flows. The second portion is located between one end of the first portion in the first direction and the outflow port. The fluid machine further includes a check valve portion that is movable along the first direction in the first portion, and is located at a first position at which the one end is closed, a second position that is located on one side in the first direction and through which the fluid can circulate between the first and second portions, and a third position at which the one end is closed and that is located on another side in the first direction with respect to the first position.

### CROSS-REFERENCE TO RELATED APPLICATIONS

The present application claims priority under 35 U.S.C. § 119 to Japanese Patent Application No. 2023-058491, filed on Mar. 31, 2023, the entire contents of which are hereby incorporated herein by reference.

### 1. FIELD OF THE INVENTION

The present invention relates to fluid machines and cooling devices.

### 2. BACKGROUND

A cooling device according to the related art includes a target cooling unit and a refrigerant replenishing unit. The target cooling unit cools a cooling target. The refrigerant replenishing unit replenishes the target cooling unit with the refrigerant. The target cooling unit is connected to the refrigerant replenishing unit such that the refrigerant can flow through the connection portion. In the connection portion, the flow path connects the target cooling unit and the refrigerant replenishing unit to each other. At the connection portion, the check valve allows the circulation of the liquid refrigerant from the refrigerant replenishing unit to the target cooling unit in the flow path, but restricts the circulation of the liquid refrigerant in the reverse direction.

However, the cooling device of the related art has room for improvement in terms of reliability. Specifically, in the related art, at least one of the flow path and the check valve may be damaged when the internal pressure of the portion on the target cooling unit side of the check valve increases in the flow path.

### SUMMARY

An example embodiment of a fluid machine of the present disclosure includes a flow path including an outflow port of a fluid, a first portion through which the fluid flows from another side to one side in a first direction, and a second portion through which the fluid flows, the second portion being located between one end of the first portion in the first direction and the outflow port, and a check valve portion movable along the first direction in the first portion, the check valve portion being located at a first position at which the one end is closed, a second position that is located on one side in the first direction with respect to the first position and through which the fluid circulates between the first portion and the second portion, and a third position at which the one end is closed and that is located on another side in the first direction with respect to the first position.

An example embodiment of a cooling device of the present disclosure includes a pipe through which a refrigerant flows, and the fluid machine.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a view illustrating a configuration of a cooling device according to an example embodiment of the present disclosure.

FIG. 2 is a perspective view illustrating a fluid machine illustrated in FIG. 1.

FIG. 3 is a perspective view of a cross section of the fluid machine taken along line III-III illustrated in FIG. 2.

FIG. 4 is a plan view of a cross section of the fluid machine taken along line III-III illustrated in FIG. 2 as viewed from one side in a second direction.

FIG. 5 is a cross-sectional view of the fluid machine in which a cross section taken along line V-V illustrated in FIG. 2 is viewed from the other side of a third direction, and in particular, is a view illustrating a check valve portion at a first position.

FIG. 6 is a cross-sectional view of the fluid machine in which a cross section taken along line V-V illustrated in FIG. 2 is viewed from the other side of a third direction, and in particular, is a view illustrating a check valve portion at a second position.

FIG. 7 is a cross-sectional view of the fluid machine in which a cross section taken along line V-V illustrated in FIG. 2 is viewed from the other side of a third direction, and in particular, is a view illustrating a check valve portion at a third position.

FIG. 8 is an exploded view of the check valve portion illustrated in FIGS. 5 to 7.

### DETAILED DESCRIPTION

Hereinafter, cooling devices according to example embodiments of the present disclosure will be described with reference to the drawings. In the drawings, the same or corresponding parts are denoted by the same reference signs and description thereof will not be repeated.

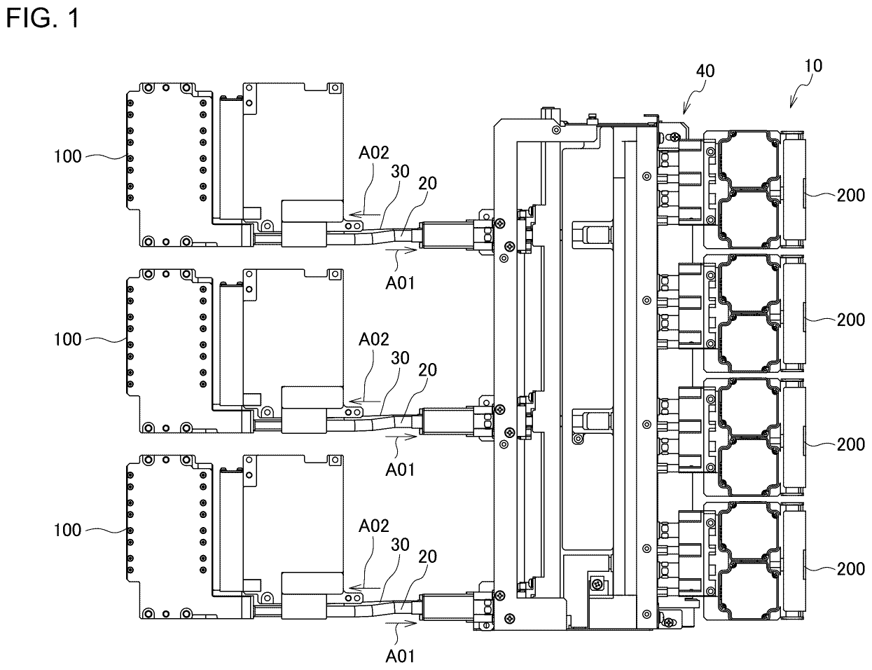

FIG. 1 is a block diagram illustrating a configuration of a CDU 10. As illustrated in FIG. 1, the CDU 10 includes at least one cold plate 100, at least one set of first pipe 20 and second pipe 30, a radiator 40, and at least one fluid machine 200. The first pipe 20 and the second pipe 30 are an example of “pipe” in the present disclosure.

The number of cold plates 100, the number of sets of the first pipes 20 and the second pipes 30, the number of radiators 40, and the number of fluid machines 200 are not limited to the number illustrated in FIG. 1. That is, the number of cold plates 100 may be other than 3. The number of sets of the first pipe 20 and the second pipe 30 may be other than 3. The number of radiators 40 may be plural. The number of fluid machines 200 may be other than 4.

The plurality of fluid machines 200 preferably have the same specification. However, some or all of the plurality of fluid machines 200 may have specifications different from each other. Each fluid machine 200 can be distributed on the market as incorporated in the CDU 10. Each fluid machine 200 can also be distributed independently in the market.

The refrigerant circulates among the cold plate 100, the first pipe 20, the radiator 40, the fluid machine 200, and the first pipe 20 and the pair of second pipes 30. The refrigerant is, for example, a coolant. Examples of the coolant include antifreeze liquid and pure water. A typical example of the antifreeze liquid is an ethylene glycol aqueous solution or a propylene glycol aqueous solution.

High-temperature refrigerant flows into the radiator 40 from the first pipe 20 (see arrow A01). The radiator 40 cools the inflowing refrigerant. The fluid machine 200 pressure-feeds the low-temperature refrigerant from the radiator 40. The low-temperature refrigerant from the plurality of fluid machines 200 flows into the plurality of cold plates 100 through the second pipe 30 (see arrow A02). The plurality of cold plates 100 come into thermal contact with the plurality of heat sources (not illustrated).

Each heat source is typically a heat generating component of the electronic device. Examples of the heat generating component include a light source of the electronic device. For example, the electronic device may be any of a server, a projector, a notebook personal computer, and a two-dimensional display device. The heat generated by the heat source moves to the refrigerant while the refrigerant flows through the plurality of cold plates 100. As a result, the temperature of the refrigerant becomes high. The high-temperature refrigerant flows from the plurality of cold plates 100 to the plurality of first pipes 20.

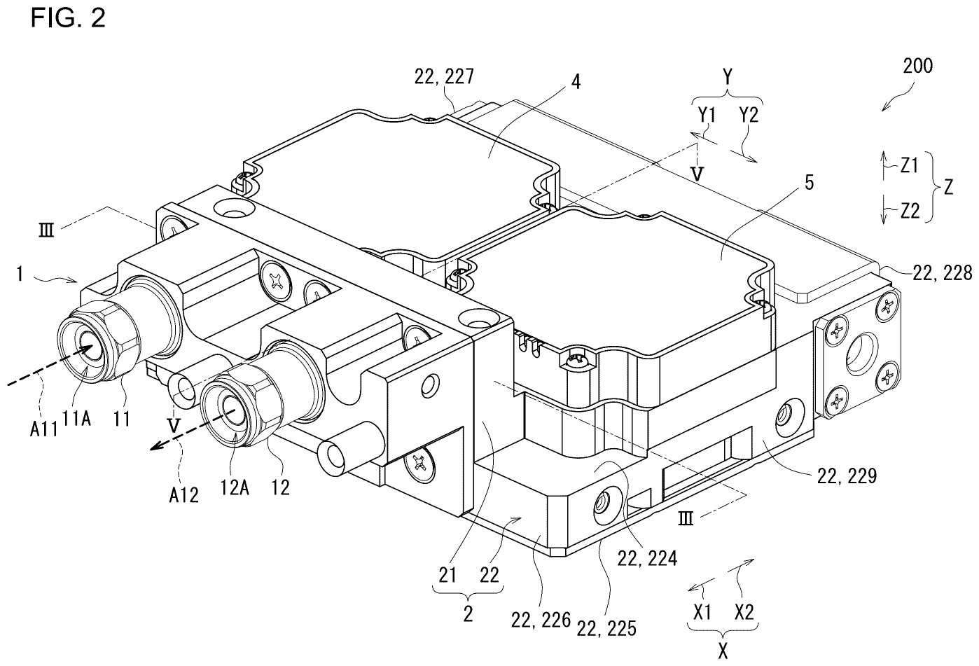

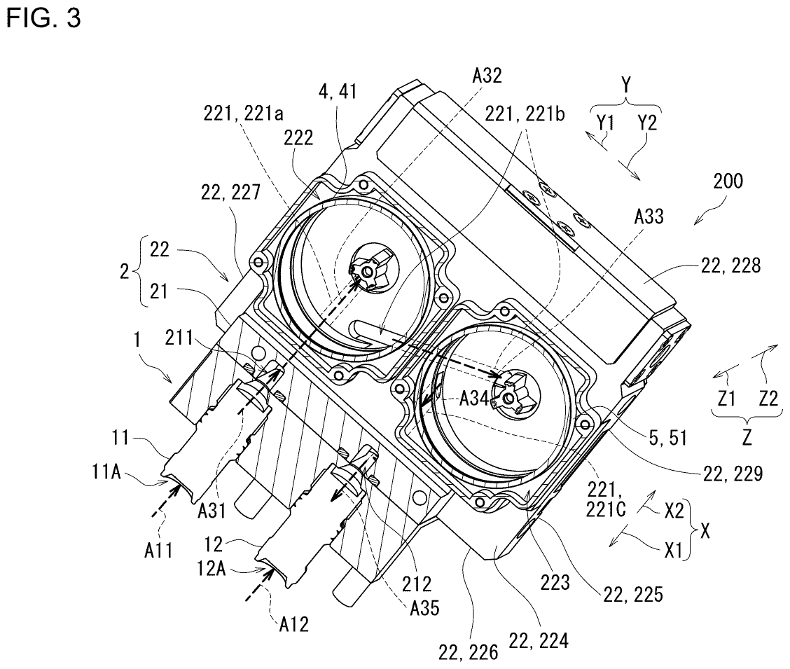

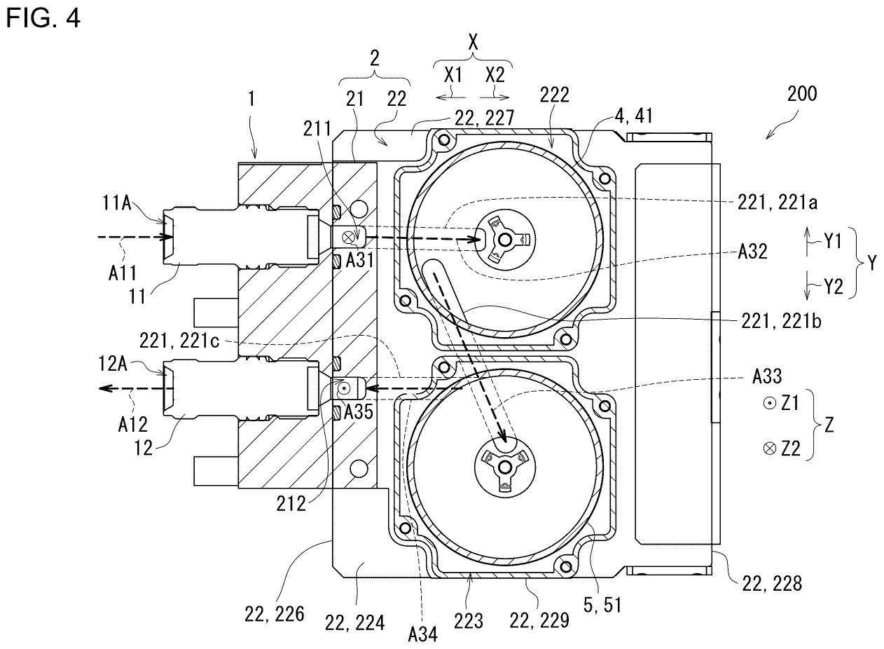

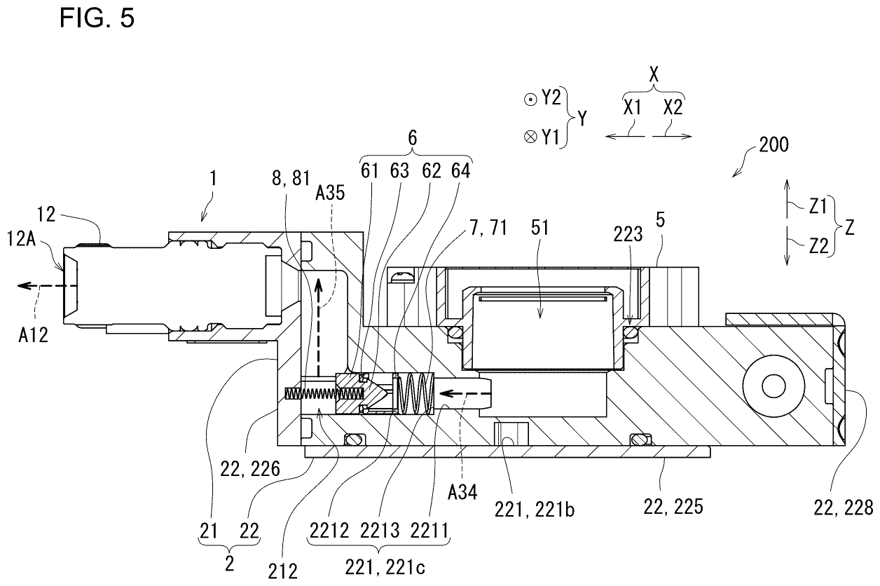

FIG. 2 is a perspective view illustrating the fluid machine 200 illustrated in FIG. 1. FIG. 3 is a perspective view of a cross section of the fluid machine 200 taken along line III-III illustrated in FIG. 2. FIG. 4 is a plan view of a cross section of the fluid machine 200 taken along line III-III illustrated in FIG. 2 as viewed from the one second direction Z1. FIGS. 5 to 7 are cross-sectional views of the fluid machine 200 when a cross section taken along line VI-VI illustrated in FIG. 2 is viewed from the other third direction Y2. In particular, FIGS. 5, 6, and 7 illustrate the check valve portion 6 at the first position, the second position, and the third position, respectively.

FIGS. 2 to 7 illustrate the first direction X, the second direction Z, and the third direction Y of the fluid machine 200 for convenience of description. The first direction X, the second direction Z, and the third direction Y intersect each other. In the example embodiment, “intersecting” includes crossing lines, planes, or lines and planes at a right angle to each other, and crossing each other at a non-right angle within a range of a slight difference (tolerance, error, or the like).

The first direction X includes one first direction X1 and the other first direction X2. The one first direction X1 is a direction in which an inflow port 11A of the refrigerant to the fluid machine 200 and an outflow port 12A of the refrigerant from the fluid machine 200 are opened. In the example embodiment, the one first direction X1 is a direction in which the refrigerant flows out from the outflow port 12A. The other first directions X2 is a direction opposite to the one first direction X1. In the example embodiment, the other first direction X2 is a direction in which the refrigerant flows into the inflow port 11A.

The second direction Z includes one second direction Z1 and the other second direction Z2 opposite to each other. The one second direction Z1 is an upward direction when a person faces the inflow port 11A and the outflow port 12A in a state where an outer wall 225 of the fluid machine 200 is directed vertically downward.

The third direction Y includes one third direction Y1 and the other third direction Y2 opposite to each other. The one third direction Y1 is a direction of the left hand when a person faces the inflow port 11A and the outflow port 12A in a state where the outer wall 225 is directed vertically downward.

Each fluid machine 200 includes a connector 1. The connector 1 is used to connect the fluid machine 200 and the radiator 40 to each other. As illustrated in FIG. 2, the connector 1 includes sockets 11 and 12.

The socket 11 has an inflow port 11A and can be connected to a first plug (not illustrated) on the radiator 40 side. In response to the connection between the socket 11 and the first plug (not illustrated), a valve provided inside the socket 11 opens. As a result, the refrigerant can flow into the fluid machine 200 from the radiator 40 through the inflow port 11A as indicated by an arrow A11.

The socket 12 has an outflow port 12A and can be connected to a second plug (not illustrated) on the radiator 40 side. In response to the connection between the socket 12 and the second plug (not illustrated), a valve provided inside the socket 12 opens. As a result, the refrigerant can flow out of the fluid machine 200 to the radiator 40 through the outflow port 12A as indicated by an arrow A12.

The sockets 11 and 12 may not be directly connected to the radiator 40. Specifically, the fluid machine 200 may be indirectly connected to the radiator 40 via a passage tube such as a pipe. In this case, the first plug and the second plug are provided in the passage tube. In the following description, the term “connection between the fluid machine 200 and the radiator 40” means that the fluid machine 200 and the radiator 40 are directly or indirectly connected.

The fluid machine 200 further includes a circulation portion 2 and pumps 4 and 5.

The circulation portion 2 includes a connection portion 21 and a main body portion 22. As clearly illustrated in FIG. 3, the connection portion 21 is connected to the connector 1 and includes an inflow portion 211 and an outflow portion 212. The inflow portion 211 is a through hole that guides the refrigerant flowing through the socket 11 to the main body portion 22 as indicated by an arrow A31. The inflow portion 211 linearly extends in the second direction Z at a position close to an end on the one third direction Y1 side in the connection portion 21. The outflow portion 212 is a through hole that guides the refrigerant flowing in the main body portion 22 to the socket 12 as indicated by an arrow A35. The outflow portion 212 linearly extends in the second direction Z at a position close to an end on the other third direction Y2 side in the connection portion 21.

The main body portion 22 includes an internal flow path 221 through which the refrigerant flows in FIGS. 4 and 5, and attachment portions 222 and 223. The pumps 4 and 5 are attached to the attachment portions 222 and 223. Specifically, each of the attachment portions 222 and 223 is recessed inside the main body portion 22. The pumps 4 and 5 are respectively fitted into the attachment portions 222 and 223. Each of the attachment portions 222 and 223 is connected to the internal flow path 221 of the main body portion 22. Therefore, the refrigerant flows into each of the attachment portions 222 and 223.

The main body portion 22 includes outer walls 224 to 229. The outer wall 224 extends in each of the first direction X and the third direction Y on the one second direction Z1 side in the main body portion 22. The attachment portions 222 and 223 are located on the outer wall 224. That is, the pumps 4 and 5 are disposed on the outer wall 224. The connection portion 21 is located on the one first direction X1 side of the outer wall 224.

The outer wall 226 expands in each of the third direction Y and the second direction Z on the one first direction X1 side in the main body portion 22. The connection portion 21 is located on the outer wall 226. That is, the inflow portion 211 and the outflow portion 212 are disposed on the outer wall 226.

The outer wall 227 extends from an end of the outer wall 226 in the one third direction Y1 toward the other first direction X2. The outer wall 227 extends in each of the first direction X and the second direction Z on the one third direction Y1 side in the main body portion 22.

The outer wall 228 expands in each of the third direction Y and the second direction Z at a position away from the outer wall 226 in the other first direction X2 on the other first direction X2 side.

The outer wall 229 extends in one first direction X1 from an end of the outer wall 228 in the other third directions Y2. The outer wall 229 extends in each of the first direction X and the second direction Z at a position away from the outer wall 227 in the other third direction Y2.

The outer wall 225 is connected to an end of each of the outer walls 226 to 229 in the other second direction Z2 and extends in each of the first direction X and the third direction Y. That is, the outer wall 225 is separated from the outer wall 224 in the other second direction Z2.

The pump 4 pressure-feeds the refrigerant flowing from the inflow portion 211 to the pump 5. As illustrated in FIGS. 2 and 4, the pump 4 has an impeller chamber 41. The pump 4 includes an impeller and a motor (not illustrated) in the impeller chamber 41. The impeller is attached to an output shaft of the motor. When the impeller rotates with the rotation of the output shaft of the motor, the pump 4 pressure-feeds the refrigerant flowing from the inflow portion 211 to the pump 5.

The pump 5 pressure-feeds the refrigerant to the outflow portion 212. As illustrated in FIGS. 2 and 4, the pump 5 has an impeller chamber 51. The pump 5 includes an impeller and a motor similar to those of the pump 4 in the impeller chamber 51, and pressure-feeds the refrigerant to the outflow portion 212.

The internal flow path 221 is defined by the outer walls 224 and 225 and the outer walls 226 to 229. In other words, the circulation portion 2 has the internal flow path 221 therein.

As illustrated in FIGS. 3 to 7, the internal flow path 221 includes partial flow paths 221a, 221b, and 221c.

The partial flow path 221a linearly extends in the first direction X (see FIGS. 3 and 4). An end of the partial flow path 221a on the one first direction X1 side is connected to an end of the inflow portion 211 on the other first direction X2 side. An end of the partial flow path 221a on the other first direction X2 side is connected to the inside of the impeller chamber 41 (see FIGS. 3 and 4).

The partial flow path 221b linearly extends from an end on one third direction Y1 toward an end on the other third direction Y2 side at a position on the other second direction Z2 side with respect to the pumps 4 and 5 in the main body portion 22 (see FIGS. 3 and 4). The partial flow path 221b is inclined with respect to each of the first direction X and the third direction Y. Specifically, the end on the one third direction Y1 side is closer to the outer wall 226 than the end on the other third direction Y2 side. An end of the partial flow path 221b on the one third direction Y1 side is connected to the inside of the impeller chamber 41. An end of the partial flow path 221b on the other third direction Y2 side is connected to the inside of the impeller chamber 51.

The partial flow path 221c linearly extends in the first direction X. An end of the partial flow path 221c on the other first direction X2 side is connected to the inside of the impeller chamber 51 at a position closer to the one second direction Z1 side than the partial flow path 221b (see FIGS. 3 and 4). An end of the partial flow path 221c on the one first direction X1 side is connected to an end of the outflow portion 212 on the other second direction Z2 side (see FIGS. 4 to 7).

In the partial flow path 221a, the refrigerant from the inflow portion 211 flows from the one first direction X1 side toward the other first direction X2 side as indicated by an arrow A32 (see FIGS. 3 and 4). Next, the refrigerant is pressure-fed in the impeller chamber 41 and flows into the partial flow path 221b. Thereafter, the refrigerant circulates in the partial flow path 221b as indicated by an arrow A33. Next, the refrigerant is pressure-fed in the impeller chamber 51 and flows into the partial flow path 221c. The refrigerant circulates in the partial flow path 221c as indicated by an arrow A34 and then flows into the outflow portion 212.

As illustrated in FIGS. 5 to 7, the partial flow path 221c has a small diameter portion 2211, a large diameter portion 2212, and a connection surface 2213. The small diameter portion 2211 linearly extends in the first direction X. The end of the small diameter portion 2211 in the other first direction X2 is connected to the inside of the impeller chamber 51. An end of the small diameter portion 2211 in the one first direction X1 is connected to an end of the large diameter portion 2212 in the other first directions X2. The cross-sectional shape of the small diameter portion 2211 is circular from one end to the other end in the first direction X. An end of the large diameter portion 2212 in the one first direction X1 is connected to an end of the outflow portion 212 on the other second direction Z2 side. The cross-sectional shape of the large diameter portion 2212 is a circle having a larger diameter than the small diameter portion 2211 from one end to the other end in the first direction X. The connection surface 2213 is a surface that connects an end of the small diameter portion 2211 on the one first direction X1 side and an end of the large diameter portion 2212 on the other first direction X2 side. The connection surface 2213 has an annular shape and faces one first direction X1.

In the partial flow path 221c, the refrigerant can flow from the other first direction X2 side to the one first direction X1 side. In the outflow portion 212, the refrigerant can flow in the second direction Z. The outflow portion 212 is positioned between an end of the partial flow path 221c in one first direction X1 and the outflow port 12A (see FIG. 2). The partial flow path 221c and the outflow portion 212 are examples of a “first portion” and a “second portion” in the present disclosure. The combination of the partial flow path 221c and the outflow portion 212 is an example of a “flow path” in the present disclosure. The refrigerant is an example of a “fluid” in the present disclosure.

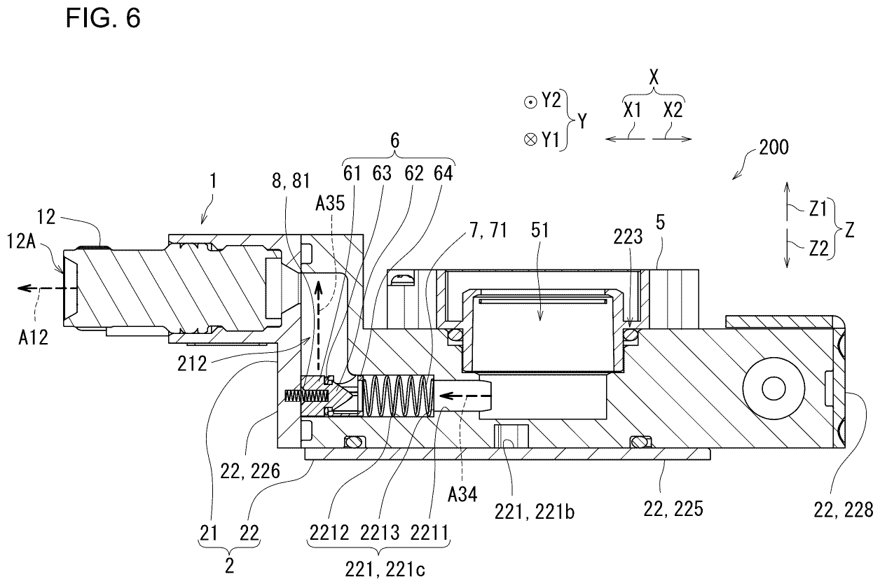

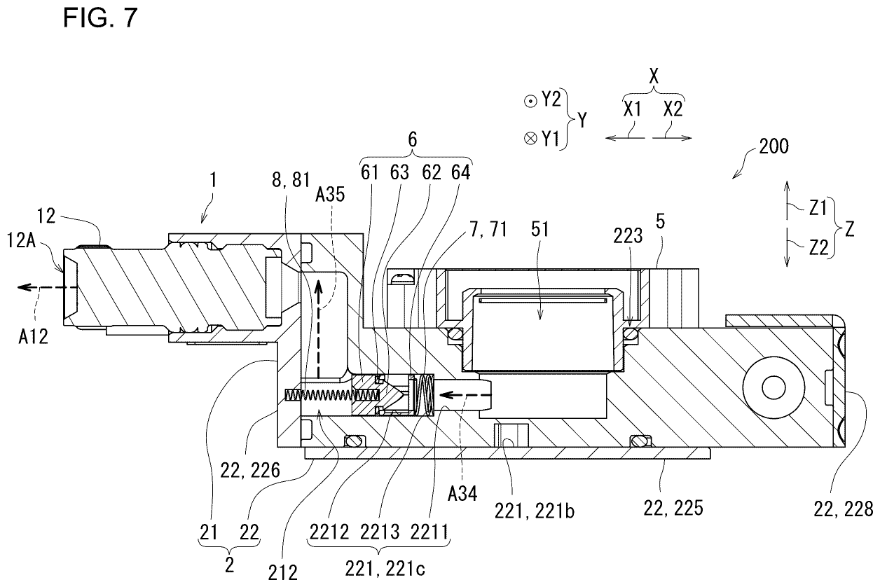

The fluid machine 200 further includes a check valve portion 6. The check valve portion 6 is movable along the first direction X in the partial flow path 221c. The check valve portion 6 can be located at a first position (see FIG. 5), a second position (see FIG. 6), and a third position (see FIG. 7).

The first position (see FIG. 5) is a position where the check valve portion 6 closes the large diameter portion 2212, that is, the end of the partial flow path 221c on the one first direction X1 side. Specifically, when the fluid machine 200 and the radiator 40 are not connected, or when the fluid machine 200 and the radiator 40 are connected but the refrigerant does not circulate, the check valve portion 6 is located at the first position.

The second position (see FIG. 6) is a position on one first direction X1 side with respect to the first position (see FIG. 5), and is a position of the check valve portion 6 where the refrigerant can circulate between the partial flow path 221c and the outflow portion 212. When the fluid machine 200 and the radiator 40 are connected and the refrigerant flows out of the outflow port 12A, the check valve portion 6 is located at the second position by the force received from the refrigerant flowing from the other first direction X2 side.

The third position (see FIG. 7) is a position in which the end on the one first direction X1 side is closed and that is located on the other first direction X2 side with respect to the first position. Also at the third position, the check valve portion 6 closes the large diameter portion 2212.

When the fluid (refrigerant or air) in the outflow portion 212 is compressed, the internal pressure increases in the outflow portion 212. Here, if the check valve portion 6 cannot move to the third position (see FIG. 7), a relatively large pressure is applied to the outflow portion 212 and the check valve portion 6, so that the outflow portion 212 and the check valve portion 6 may be damaged. However, in the example embodiment, the check valve portion 6 moves to the third position (see FIG. 7) when the internal pressure increases. Therefore, the pressure received by the outflow portion 212 and the check valve portion 6 decreases. Therefore, at least one of the outflow portion 212 and the check valve portion 6 is less likely to be damaged.

The increase in the internal pressure occurs, for example, when the valve in the socket 12 moves in the other first direction X2 in response to the connection of the second plug (not illustrated) to the socket 12. The increase in the internal pressure causes the check valve portion 6 to move to the third position (see FIG. 7). Therefore, at least one of the outflow portion 212 and the check valve portion 6 is less likely to be damaged.

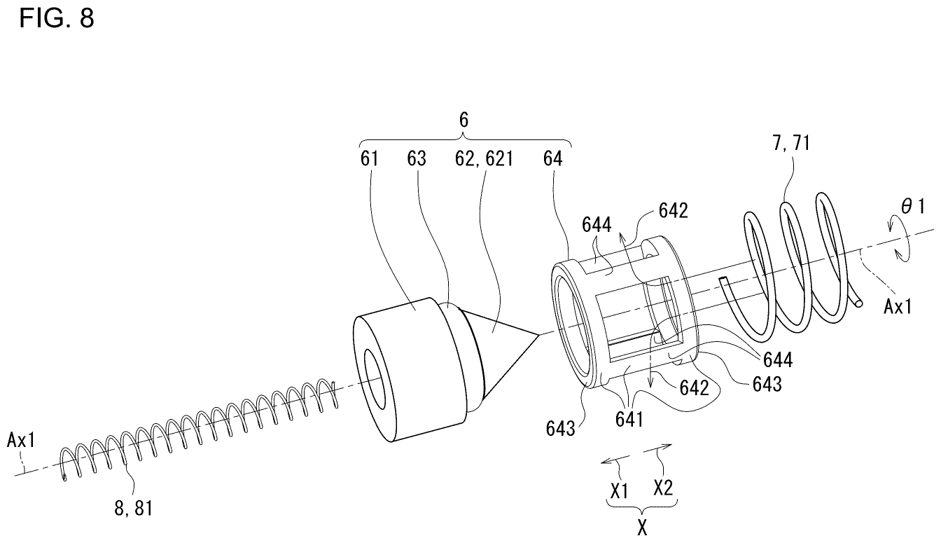

FIG. 9 is an exploded view of the check valve portion 6. As illustrated in FIGS. 5 to 8, the check valve portion 6 includes a valve body 61, a protruding portion 62, an O-ring 63, and a flow path member 64.

The valve body 61 is biased by a biasing portion 8. The valve body 61 is a cylindrical body having substantially the same diameter as the large diameter portion 2212 or having a slightly smaller diameter than the large diameter portion 2212. The valve body 61 is smaller in dimension in the first direction X than the large diameter portion 2212. The valve body 61 is typically made of a hard resin.

The protruding portion 62 protrudes in the other first direction X2 from an end portion of the valve body 61 on the other first direction X2 side. The protruding portion 62 is smaller than the valve body 61 in dimension in the second direction Z from one end to the other end in the first direction X.

The protruding portion 62 has an outer peripheral surface 621 having a smaller dimension in the second direction Z from a position slightly away from the end portion of the valve body 61 on the other first direction X2 side in the other first direction X2 toward the other first direction X2. Specifically, the outer peripheral surface 621 forms a cone. Therefore, when the refrigerant flows from the other first direction X2, the surface area of the outer peripheral surface 621 is relatively large, so that a relatively large pressure is received from the refrigerant. As a result, the check valve portion 6 can quickly move from the first position (see FIG. 5) to the second position (see FIG. 6) when the refrigerant flows into the large diameter portion 2212.

In the protruding portion 62, an annular groove extending in a circumferential direction θ1 of a central axis Ax1 of each of the valve body 61 and the outer peripheral surface 621 of the cone is formed between the outer peripheral surface 621 and the valve body 61 in the first direction X. The annular O-ring 63 made of an elastic material such as rubber or synthetic resin is attached to the groove. That is, the O-ring 63 is provided in the valve body 61. Specifically, the O-ring 63 abuts on the valve body 61 and is mounted along the outer periphery of the protruding portion 62. The O-ring 63 is an example of a “sealing portion” in the present disclosure. The outer diameter of the O-ring 63 protrudes outward from the outer peripheral surface 621.

The flow path member 64 abuts on the O-ring 63 from the other first direction X2 side and is biased by a biasing portion 7. The flow path member 64 is a separate member from the valve body 61, and the O-ring 63 is interposed therebetween. The check valve portion 6 having such a configuration is movable to the third position (see FIG. 7) in the partial flow path 221c. Therefore, it is possible to prevent the backflow from the outflow portion 212 to the partial flow path 221c while achieving a high sealing property when the internal pressure increases. The flow path member 64 is an example of an “abutting portion” in the present disclosure.

The flow path member 64 has a flow path 642 extending from an end of the other first direction X2 to an outer peripheral surface 641 of the flow path member 64 in the second direction Z.

Since the check valve portion 6 includes the valve body 61, the protruding portion 62, the O-ring 63, and the flow path member 64, the assembly property and the sealing property are improved.

Specifically, the flow path member 64 is typically made of a resin material. In the example embodiment, as illustrated in FIG. 9, the flow path member 64 has two annular portions 643 and four connection portions 644. The two annular portions 643 are located apart from each other in the first direction X. The inner diameter of each annular portion 643 is slightly larger than the outer diameter of the outer peripheral surface 621. The outer diameter of each annular portion 643 is slightly smaller than the outer diameter of the O-ring 63. The four connection portions 644 extend in the first direction X between the two annular portions 643. The four connection portions 644 are arranged at intervals in the circumferential direction θ1. The flow path member 64 is not limited to the above, and can be realized by forming a through hole in the cylindrical body.

The fluid machine 200 further includes biasing portions 7 and 8. The biasing portions 7 and 8 are examples of a “first biasing portion” and a “second biasing portion” in the present disclosure.

The biasing portion 7 biases the check valve portion 6 from the other first direction X2 side to the one first direction X1 side. The biasing portion 8 biases the check valve portion 6 from the one first direction X1 side to the other first direction X2 side. Therefore, the check valve portion 6 can be moved in one first direction X1 and the other first direction X2 with a simple configuration.

The biasing force applied to the check valve portion 6 by the biasing portions 7 and 8 is appropriately adjusted so as to satisfy the following conditions (a) to (c). The condition (a) is that the check valve portion 6 is located at the first position when the fluid machine 200 and the radiator 40 are not connected, or when the fluid machine 200 and the radiator 40 are connected but the refrigerant does not circulate. The condition (b) is that the check valve portion 6 is located at the second position (see FIG. 6) when the refrigerant flows out of the outflow port 12A in a state where the fluid machine 200 and the radiator 40 are connected. The condition (c) is that the check valve portion 6 moves to the third position (see FIG. 7) in the process of connecting the second plug (not illustrated) on the radiator 40 side to the socket 12.

More specifically, the biasing portions 7 and 8 are springs 71 and 81. The springs 71 and 81 are examples of a “first spring” and a “second spring” in the present disclosure.

The outer diameter of the spring 71 is substantially the same as the large diameter portion 2212 or slightly smaller than the diameter of the large diameter portion 2212. The spring 71 is disposed between the connection surface 2213 and an end of the flow path member 64 on the other first direction X2 side. Specifically, one end of the spring 71 abuts on an end of the flow path member 64 on the other first direction X2 side. The other end of the spring 71 abuts on the connection surface 2213.

The outer diameter of the spring 81 is much smaller than the diameter of the large diameter portion 2212. The spring 81 is disposed between the end of the valve body 61 on the one first direction X1 side and the inner peripheral surface of the outflow portion 212. Specifically, one end of the spring 81 abuts on a portion facing the valve body 61 in the one first direction X1 on the inner peripheral surface of the outflow portion 212. The other end of the spring 81 abuts on the end of the valve body 61 on the one first direction X1 side.

Here, the outflow port 12A is separated from the partial flow path 221c in the second direction Z. The outflow portion 212 extends in the second direction Z between the partial flow path 221c and the outflow port 12A. By configuring the partial flow path 221c and the outflow portion 212 as described above, one end of the spring 81 can abut against the inner peripheral surface of the outflow portion 212. That is, the configuration of the fluid machine 200 is simplified by effectively using the inner peripheral surface of the outflow portion 212.

The spring constant of the spring 81 is smaller than the spring constant of the spring 71. That is, the spring 81 more easily expands and contracts than the spring 71. Therefore, when the refrigerant flows in the internal flow path 221, the check valve portion 6 easily moves from the first position (see FIG. 5) to the second position (see FIG. 6). Specifically, out of the valve body 61 and the flow path member 64, only the valve body 61 may move by the pressure from the refrigerant. In this case, since a gap is generated between the valve body 61 and the flow path member 64, the refrigerant can circulate through the gap.

Each of the springs 71 and 81 is typically a coil spring. The coil spring may be either a tension coil spring or a compression coil spring.

Hereinafter, a modification of the example embodiment will be described. In the example embodiment, the outflow portion 212 intersects the partial flow path 221c at a substantially right angle. However, the present disclosure is not limited thereto, and the outflow portion 212 may only be inclined with respect to the partial flow path 221c.

In the example embodiment, the fluid machine 200 includes two pumps 4 and 5. However, the number of pumps may be other than two.

In the example embodiment, the valve body 61 and the flow path member 64 are separate members. However, the present disclosure is not limited thereto, and the valve body 61 and the flow path member 64 may be integrated.

The refrigerant may be a gas refrigerant.

In the example embodiment, the cross-sectional shapes of the small diameter portion 2211 and the large diameter portion 2212 are circular. However, the present disclosure is not limited thereto, and these cross-sectional shapes may be polygonal.

In the example embodiment, the outer peripheral surface 621 is a cone. However, the present disclosure is not limited thereto, and the outer peripheral surface 621 may be a pyramid.

The example embodiment and modification of the present disclosure have been described with reference to the drawings. However, the present disclosure is not limited to the above example embodiment and the modification, and can be implemented in various modes without departing from the gist of the present disclosure. The plurality of constituent elements disclosed in the above example embodiment and the modification can be appropriately modified.

The drawings schematically illustrate each constituent element mainly in order to facilitate understanding of the disclosure, and the thickness, length, number, interval, and the like of the illustrated constituent elements may be different from the actual ones for convenience of creation of the drawings. The configuration of each constituent element illustrated in the above example embodiment is an example and is not particularly limited, and it goes without saying that various modifications can be made without substantially departing from the effects of the present disclosure.

The techniques according to example embodiments of the present disclosure can have the following configurations.
(1) A fluid machine including a flow path including an outflow port of a fluid, a first portion through which the fluid flows from another side to one side in a first direction, and a second portion through which the fluid flows, the second portion being located between one end of the first portion in the first direction and the outflow port, and a check valve portion movable along the first direction in the first portion, the check valve portion being located at a first position at which the one end is closed, a second position that is located on one side in the first direction with respect to the first position and through which the fluid circulates between the first portion and the second portion, and a third position at which the one end is closed and that is located on another side in the first direction with respect to the first position.
(2) The fluid machine according to (1), further including a socket, in which an internal pressure of the second portion increases in response to connection of a pair of plugs of the socket to the socket, and the check valve portion moves to the third position.
(3) The fluid machinery of (1) or (2), further including a first biasing portion that biases the check valve portion from another side to one side in the first direction, and a second biasing portion that biases the check valve portion from one side to another side in the first direction.
(4) The fluid machinery according to any one of (1) to (3), in which the check valve portion includes a valve body biased by the second biasing portion, a sealing portion provided on the valve body, and an abutting portion that abuts on the sealing portion from another side in the first direction and is biased by the first biasing portion.
(5) The fluid machine according to (3) or (4), in which the first biasing portion includes a first spring, the second biasing portion includes a second spring, and a spring constant of the second spring is smaller than a spring constant of the first spring.
(6) The fluid machine according to any one of (1) to (5), in which the check valve portion further includes a protruding portion that protrudes from another end portion in the first direction of the valve body to another side in the first direction, and has a smaller dimension in a second direction intersecting the first direction than the valve body, and the protruding portion includes an outer peripheral surface having a smaller dimension in the second direction toward another side in the first direction.
(7) The fluid machine according to any one of (1) to (6), in which the outflow port is separated from the first portion in the second direction, and the second portion extends in the second direction between the one end and the outflow port.
(8) A cooling device including a pipe through which a refrigerant flows, and a fluid machine according to any one of (1) to (7).

The fluid machines and the cooling devices according to example embodiments of the present disclosure have industrial applicability.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A fluid machine comprising:
a flow path including an outflow port of a fluid, a first portion through which the fluid flows from another side to one side in a first direction, and a second portion through which the fluid flows, the second portion being located between one end of the first portion in the first direction and the outflow port; and
a check valve portion movable along the first direction in the first portion, the check valve portion being located at a first position at which the one end is closed, a second position that is located on one side in the first direction with respect to the first position and through which the fluid circulates between the first portion and the second portion, and a third position at which the one end is closed and that is located on another side in the first direction with respect to the first position.

2. The fluid machine according to claim 1, further comprising a socket, wherein an internal pressure of the second portion increases in response to connection of a pair of plugs of the socket to the socket, and the check valve portion moves to the third position.

3. The fluid machinery of claim 1, further comprising:
a first biasing portion that biases the check valve portion from another side to one side in the first direction; and
a second biasing portion that biases the check valve portion from one side to another side in the first direction.

4. The fluid machinery of claim 3, wherein
the check valve portion includes:
a valve body biased by the second biasing portion;
a sealing portion provided on the valve body; and
an abutting portion that abuts on the sealing portion from another side in the first direction and is biased by the first biasing portion.

5. The fluid machine according to claim 4, wherein
the first biasing portion includes a first spring;
the second biasing portion includes a second spring; and
a spring constant of the second spring is smaller than a spring constant of the first spring.

6. The fluid machine according to claim 4, wherein
the check valve portion further includes a protruding portion that protrudes from another end portion in the first direction of the valve body to another side in the first direction, and has a smaller dimension in a second direction intersecting the first direction than the valve body, and
the protruding portion includes an outer peripheral surface having a smaller dimension in the second direction toward another side in the first direction.

7. The fluid machine according to claim 1, wherein
the outflow port is separated from the first portion in the second direction; and
the second portion extends in the second direction between the one end and the outflow port.

8. A cooling device comprising:
a pipe through which a refrigerant flows; and
a fluid machine according to claim 1.
